(19) United States
(12) Patent Application Publication
(10) Pub. No.: US 2015/0189059 A1
(43) Pub. Date: Jul. 2, 2015

(54) HDMI Communication System for Electronic Devices and Methods Therefor

(71) Applicant: Motorola Mobility LLC, Libertyville, IL (US)

(72) Inventor: Howard H. Shen, Los Altos, CA (US)

(73) Assignee: Motorola Mobility LLC, Libertyville, IL (US)

(21) Appl. No.: 14/147,036

(22) Filed: Jan. 3, 2014

Related U.S. Application Data
(60) Provisional application No. 61/921,250, filed on Dec. 27, 2013.

(51) Int. Cl. H04M 1/725; H04M 1/02

(52) U.S. Cl. CPC H04M 1/7253; H04M 1/0274

(57) ABSTRACT

A system includes a mobile communication device and a communication companion device to communicate with the mobile communication device. The communication companion device can include a high-definition multimedia (HDMI) connector to couple to a remote device. The mobile communication device and the communication companion device to exchange an authentication key to enable communication therebetween when the HDMI connector is coupled to the remote device. The mobile communication device can be used as an input control, in the form of a mouse in one embodiment, to control the presentation of data on the remote device.

### CROSS REFERENCE TO PRIOR APPLICATIONS

This application claims priority and benefit under 35 U.S.C. §119(e) from U.S. Provisional Application No. 61/921,250, filed Dec. 27, 2013, which is incorporated by reference for all purposes.

### BACKGROUND

1. Technical Field

This disclosure relates generally to electronic devices, and more particularly to electronic communication devices.

2. Background Art

Electronic devices, such as mobile telephones, smart phones, gaming devices, and the like, present information to users on a display. As these devices have become more sophisticated, so too have their displays and the information that can be presented on them. For example, not too long ago a mobile phone included a rudimentary light emitting diode display capable of only presenting numbers and letters configured as seven-segment characters. Today, high-resolution liquid crystal and other displays included with mobile communication devices and smart phones can be capable of presenting high-resolution video.

At the same time, advances in electronic device design have resulting in many devices becoming smaller and smaller. Portable electronic devices that once were the size of a shoebox now fit easily in a pocket. The reduction in size of the overall device means that the displays, despite becoming more sophisticated, have gotten smaller. It is sometimes challenging, when using small user interfaces, to conveniently view information on small displays.

Networking technologies have been developed that allow a user to share information from between some devices. The problem with such networking technologies is that they sometimes require “compatible” devices. Where devices are not compatible, there may be no way to share information on one device with another. For example, if a person desires to show pictures from a mobile communication device on a television, there may be no way to connect the two devices together—even using a wire. While device specific connectors may be available, they are often expensive and are further cumbersome to carry. It would be advantageous to have an improved system to enable more efficient presentation of information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates an explanatory system configured in accordance with one or more embodiments of the disclosure.

FIG. 2 illustrates an explanatory mobile communication device device configured in accordance with one or more embodiments of the disclosure.

FIG. 3 illustrates an explanatory mobile communication device and communication companion device configured in accordance with one or more embodiments of the disclosure.

FIG. 4 illustrates one example of a communication companion device configured in accordance with one or more embodiments of the disclosure.

FIG. 5 illustrates an alternate system configured in accordance with one or more embodiments of the disclosure.

FIG. 6 illustrates an alternate mobile communication device and communication companion device configured in accordance with one or more embodiments of the disclosure.

FIG. 7 illustrates one explanatory method in accordance with one or more embodiments of the disclosure.

FIG. 8 illustrates an explanatory use case in accordance with one or more embodiments of the disclosure.

FIG. 9 illustrates another explanatory use case to control presentation of output on a remote device using a mobile communication device as a control device in accordance with one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to communication and authentication between a mobile communication device and a communication companion device. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of authentication, communication, and information sharing between a mobile communication device and a communication companion device as described herein. The non-processor circuits may include, but are not limited to, a radio receiver, a radio transmitter, signal drivers, clock circuits, power source circuits, and user input devices. As such, these functions may be interpreted as steps of a method to perform communication, authentication, and information sharing between the mobile communication device and the communication companion device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Wireless connectivity among electronic devices is now prevalent. Wi-Fi “hotspots” exist in nearly every home, business, school, and coffee shop. The development of generally accepted wireless communication standards, such as the IEEE 802.11 standard, allows diverse devices to communicate with each other in local area networks. For example, it is not uncommon for a person use a Wi-Fi router connected to the Internet to enable them to watch television, surf the web on a computer, and check the weather on a smart phone, with each of these different devices communicating with the router. The world is an incredible place.

As the number of, and ease of communication with, hotspots has increased, so too have worries about data security. While it may be easy to find hotspots in many urban areas, finding those without password registration (or other stricter security measures) is almost impossible. Moreover, hotspot managers are frequently reluctant to share passwords or registration credentials with guests. One compromise of a password or login credential requires the entire system to be reconfigured. This presents difficulties for guest users.

Illustrating by way of example, presume Host A hosts a dinner party at their home. They have a wireless router protected with a password. Guest B enters the home having just returned from touring the world famous vineyards of Burgundy. Guest B is armed with a smart phone loaded with pictures of the Cote de Nuits, and is itching to share them with the entire dinner party. However, it is far too cumbersome for everyone to gather around a three-inch display. To make matters worse, some of the dinner guests need glasses to see such a small display and forgot to bring them to the party.

Guest B then asks Host A, “Host A, let me into your Wi-Fi network so I can show these great shot of Pinot Noir grapes! What's the password, man?” Host A, however, is reluctant to share the password as he runs a small business from his home. Announcing the password not only compromises security by telling each and every guest what the password is, but also would allow Guest B access to sensitive client files. Host A thus demurs. The guests are downtrodden that they will not be able to see how the wines of the great Burgundian style are made. Tensions flare between Host A and Guest B. Friendships are tested. All of this drama stems from the fact that Guest B asked Host A for security credentials so Guest B could show a few snapshots. This scenario is all too common.

Embodiments of this disclosure provide systems and methods to avoid this problem. With embodiments of the present disclosure, guests are no longer downtrodden, but are elated as images of Chambertin, Clos de la Roche, and Clos de Vougeot jump to life on a sixty-inch plasma display. With embodiments of the disclosure, tensions do not flare between Host A and Guest B because Guest B never has to ask, “What's the password, man?” With embodiments of the disclosure, friendships are not tested, but rather remain strong. With embodiments of the disclosure, the hypothetical dinner party set forth above is a flawless success.

The reason this is the case is because embodiments of the disclosure provide a communication companion device that is to communicate with a mobile communication device. In one embodiment, the communication companion device is “keyed” to the mobile communication device in that the mobile communication device and the communication companion device exchange an authentication key to enable communication between each device when the communication companion device is coupled to a remote device. In one embodiment, this exchange of the authentication key occurs without any input from the user. In this manner, the communication between the communication companion device and the mobile communication device appears seamless and instant. To the user, “it just works.”

In one embodiment, the communication companion device comprises a high-definition multimedia (HDMI) connector to couple to a remote device. Accordingly, using the hypothetical dinner party scenario from above, Guest B simply plugs the HDMI connector into an HDMI device at Host A's house. Once connected, the communication companion device is to exchange an authentication key or other credentials to enable communication between a mobile communication device and the communication companion device. As note above, this exchange occurs without input from the user in one or more embodiments. Once the authentication key is exchanged, the mobile communication device and the communication companion device exchange data directly, i.e., the communication does not need to go through Host A's router or network. Accordingly, Guest B can show his winery photos without requiring access to Host A's network.

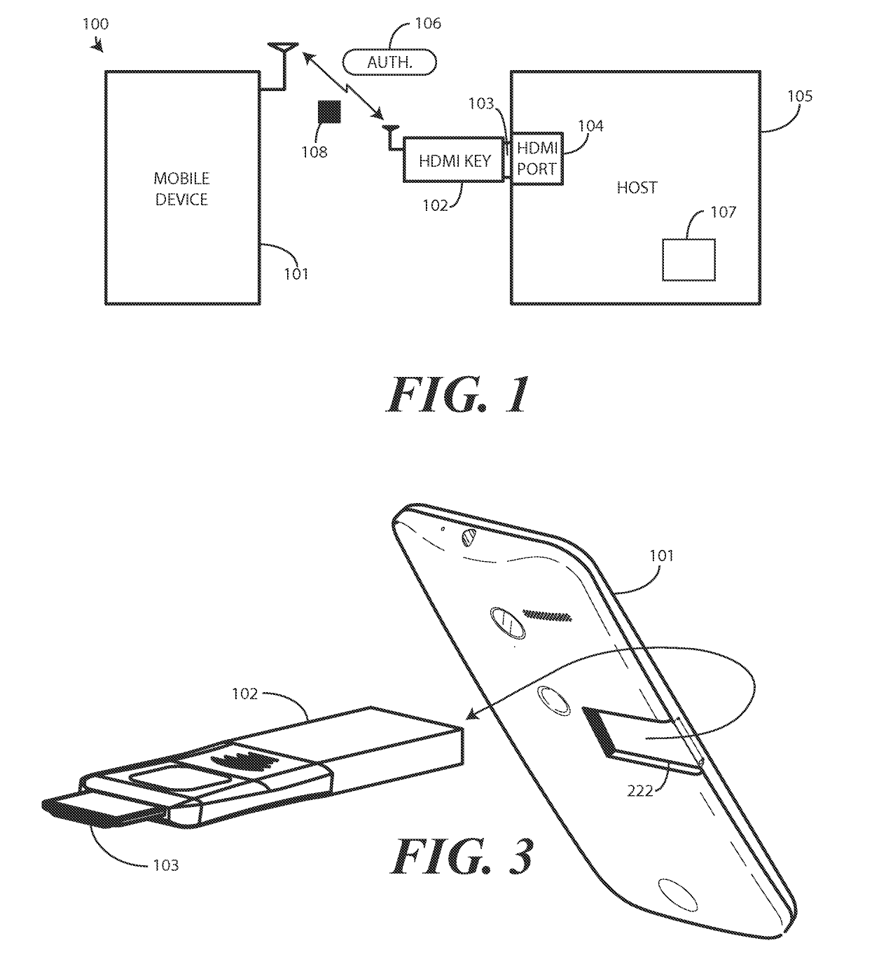

Turning now to FIG. 1, illustrated therein is a system 100 in accordance with one or more embodiments of the disclosure. In one embodiment, the system 100 includes a mobile communication device 101 and a communication companion device 102 to communicate with the mobile communication device 101. For ease of illustration, a smart phone will be used as one explanatory mobile communication device 101 in the description that follows below. However, it will be obvious to those of ordinary skill in the art having the benefit of this disclosure that other electronic devices may be substituted for the explanatory smart phone of FIG. 1. For example, the mobile communication device 101 may be configured as a palm-top computer, a tablet computer, a gaming device, wearable computer, a media player, or other device. In one embodiment, the mobile communication device 101 may have no display at all, and may be a small computing device—about the size of a computer mouse—that uses the communication companion device 102 to leverage the display of a remote device 105 as its visual output device.

In one embodiment, the communication companion device 102 comprises an HDMI connector 103. The HDMI connector 103 can connect to an HDMI port 104 of a remote device 105. Illustrating by example, in one embodiment the remote device 105 is a monitor, such as a computer monitor or television equipped with an HDMI port 104. Examples of remote devices include computers, set-top boxes, DVD and other media players, gaming consoles, and audio/video receivers. Other examples include computer monitors, high definition televisions, video projectors, and digital audio devices. Still other examples will be obvious to those of ordinary skill in the art having the benefit of this disclosure.

In one embodiment, the mobile communication device 101 and the communication companion device 102 are to exchange an authentication key 106 to enable communication therebetween when the HDMI connector 103 is coupled to the HDMI port 104 of the remote device 105. In another embodiment, no authentication is required. Authentication can be advantageous in that it allows a specific companion device 102 to communicate with a specific mobile communication device 101 on a one-to-one basis. However, embodiments of the disclosure are not so limited. Those of ordinary skill in the art having the benefit of this disclosure will appreciate that some users will prefer devices where authentication is not required. To accommodate such users, in one embodiment the mobile communication device 101 and the communication companion device 102 are to begin communication without any authentication whatsoever. In either case, the mobile communication device 101 and the communication companion device 102 can either exchange the authentication key 106 without input from a user, or automatically start communicating without any input from the user and without authentication, with both techniques enabling data communication between the mobile communication device 101 and the communication companion device 102 automatically. This provides a seamless experience for the user.

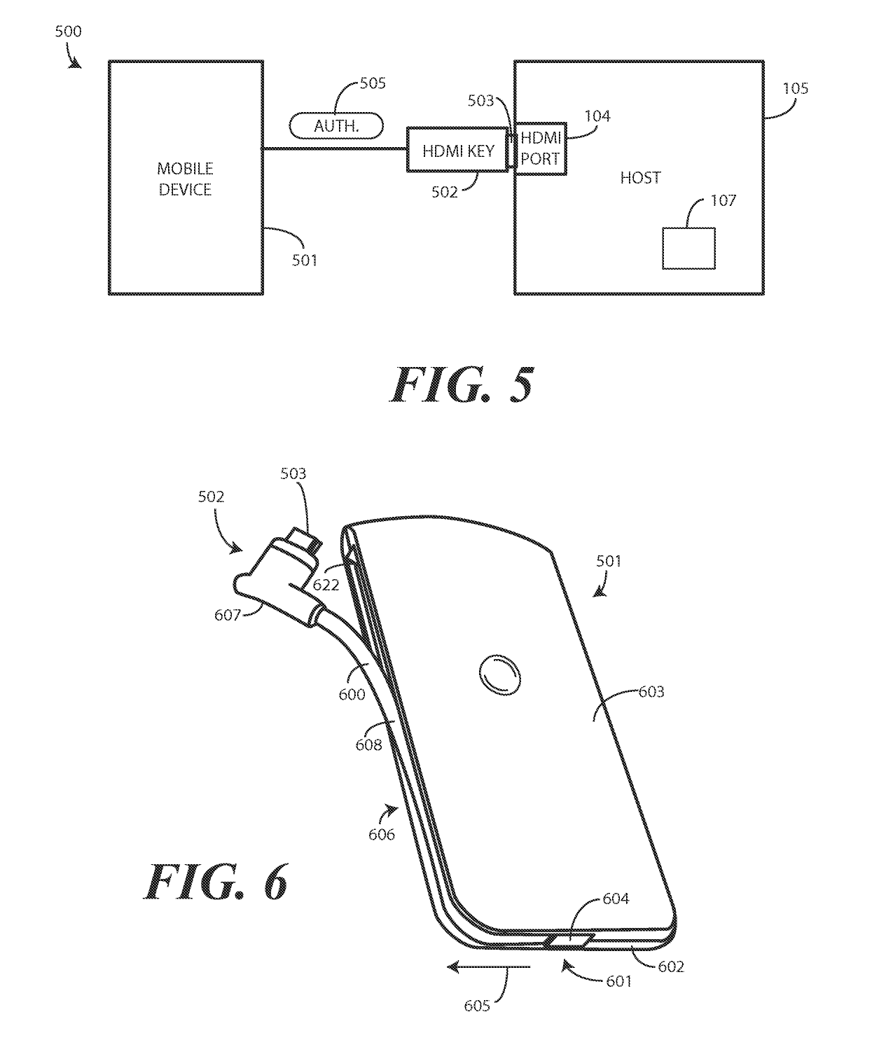

In the illustrative embodiment of FIG. 1, the communication companion device 102 comprises a wireless communication companion device to wirelessly communicate with the mobile communication device 101. Accordingly, the mobile communication device 101 can transmit data 108 for presentation on an output device 107 of the remote device 105. Examples of output devices include a display, loudspeakers, tactile devices, optical devices, and so forth. In addition to the wireless configuration of FIG. 1, other configurations are also possible, as will be shown in the discussion of FIG. 5 below.

In one embodiment, memory devices in each of the mobile communication device 101 and the communication companion device 102 have authentication credentials that are both unique and hard coded in each device, and that can be verified by one or more processors operable with the memory devices to facilitate data communication. Said differently, in one embodiment the mobile communication device 101 and the communication companion device 102 are pre-programmed to communicate only with the other device and not to communicate with other devices. Accordingly, the mobile communication device 101 and the communication companion device 102 can be configured to authenticate on a one-to-one basis.

Illustrating by example, in one embodiment each of the mobile communication device 101 and the communication companion device 102 has an authentication key 106 that is written to non-volatile memory. By confirming that their locally stored authentication keys match, one or more processors of the mobile communication device 101 and the communication companion device 102 can perform an authentication process to enable data communication. This is one example of “exchanging” the authentication key 106. Others will be obvious to those of ordinary skill in the art having the benefit of this disclosure.

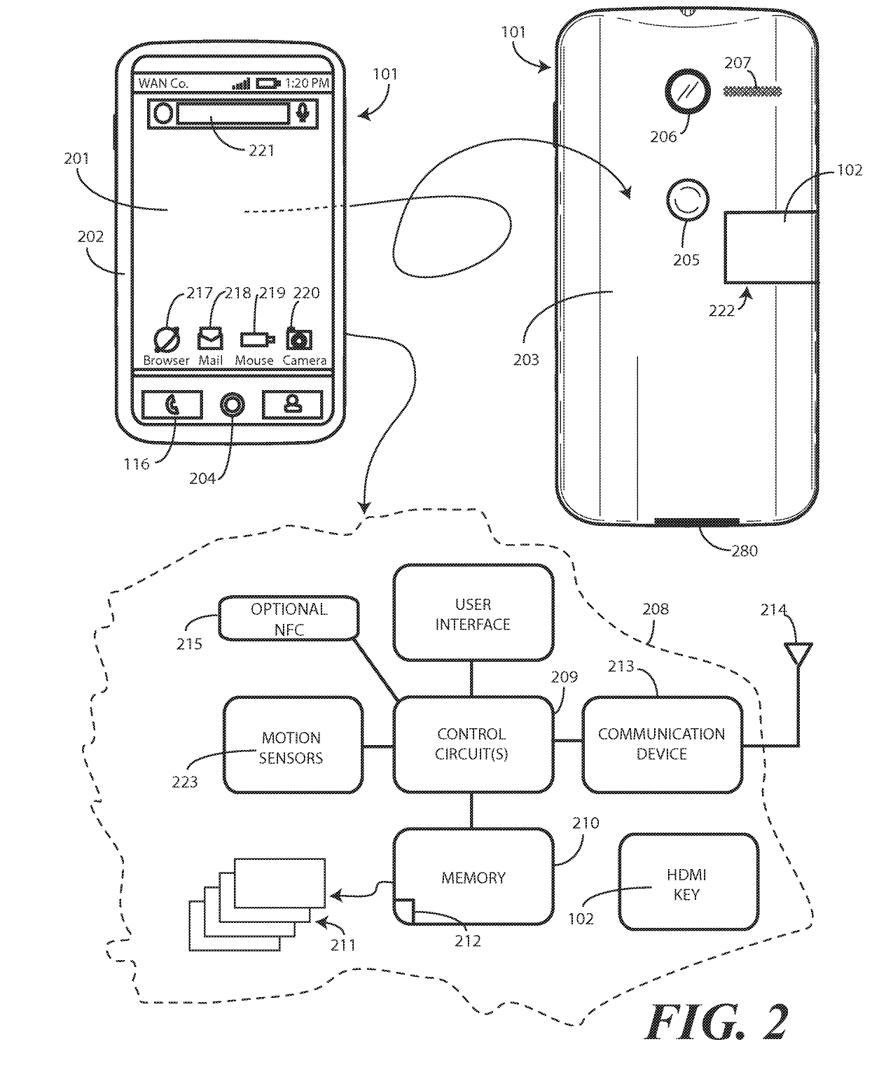

Turning now to FIG. 2, illustrated therein is one embodiment of a mobile communication device 101 configured in accordance with one or more embodiments of the disclosure. This illustrative mobile communication device 101 includes a touch-sensitive display 201. In one embodiment, the touch-sensitive display 201 is touch-sensitive and is configured as an organic light emitting diode display. However, an organic light emitting diode display is one type of touch-sensitive display 201 suitable for use with the disclosure, and will accordingly be used for explanatory purposes in this disclosure. However, it should be noted that other types of displays, including liquid crystal displays, would be obvious to those of ordinary skill in the art having the benefit of this disclosure.

The explanatory mobile communication device 101 of FIG. 2 includes two housing members. An upper housing member 202 is disposed about the periphery of the touch-sensitive display 201. A lower housing member 203 forms the backside of the mobile communication device 101 in this illustrative embodiment. Features can be incorporated into the housing members, including optional control buttons 204,205, an optional camera 206, and an optional speaker port 207.

A block diagram schematic 208 of the mobile communication device 101 is also shown in FIG. 2. In one embodiment, the mobile communication device 101 includes a control circuit 209, which can include one or more processors. The control circuit 209 can be responsible for performing the various functions of the mobile communication device 101. The control circuit 209 can be a microprocessor, a group of processing components, one or more Application Specific Integrated Circuits (ASICs), programmable logic, or other type of processing device. The control circuit 209 can be operable with the various components of the mobile communication device 101.

The control circuit 209 can be configured to process and execute executable software code to perform the various functions of the mobile communication device 101. A storage device, such as memory 210, stores the executable software code used by the control circuit 209 for device operation. In one embodiment, the memory 210 comprises at least some non-volatile memory 212. The executable software code used by the control circuit 209 can be configured as one or more modules 211 that are operable with the control circuit 209. Such modules 211 can store instructions, control algorithms, and so forth. The instructions can instruct processors or control circuit 209 to perform the various steps of the methods described herein.

For example, in one embodiment the one or modules 211 can include instructions enabling the control circuit 209 to authenticate the communication companion device 102 for data communication by exchanging the authentication key 106, which is stored in the non-volatile memory 212 in one or more embodiments.

In this illustrative embodiment, the mobile communication device 101 also includes a communication circuit 213 that can be configured for wired and/or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, and other networks. The communication circuit 213 can include wireless communication circuitry, one of a receiver, a transmitter, or transceiver, and one or more antennas 214.

In one embodiment, the mobile communication device 101 also includes an optional near field communication circuit 215. The near field communication circuit 215 can be operable with the control circuit 209 to permit the mobile communication device 101 to communicate with near field communication object. For example, in one embodiment described below, the near field communication circuit 215 can be used to communicate with the communication companion device 102. This application for the near field communication circuit 215 is illustrative only, as others will be obvious to one of ordinary skill in the art having the benefit of this disclosure. In one embodiment, the near field communication circuit 215 is operable with a wireless near field communication transceiver, which in one embodiment is a form of radio-frequency device configured to send and receive radio-frequency data to remote near field communication devices or accessory devices. The near field communication circuit 215 can have its own near field communication circuit controller in one or more embodiments to wirelessly communicate with a variety of near field communication devices employing various near field communication technologies and protocols. The near field communication circuit 215 can include—as an antenna—a communication coil that is configured for near-field communication at a particular communication frequency. In one embodiment, the communication coil is wrapped about a ferrite or other material. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data.

The mobile communication device 101 includes an associated operating system environment, which is configured as executable code operating on one or more processors or control circuits of the mobile communication device 101. In this illustrative embodiment, the operating system environment has associated therewith various applications or “apps.” Examples of such applications shown in FIG. 2 include a cellular telephone application 216 for making voice telephone calls, a navigation application 218 configured to provide mapping and navigation information to the user on the display 201 of the mobile communication device 101, an electronic mail application 219 configured to send and receive electronic mail, and a camera application 219 configured to capture still (and optionally video) images. An Internet and/or local search application 221 is also provided. These applications are illustrative only, as others will be obvious to one of ordinary skill in the art having the benefit of this disclosure.

In one embodiment, the mobile communication device 101 also includes a communication companion device sharing application 219. By launching this application, the user can share images, contacts, lists, songs, media, desirous information on persons, places, and things, and so forth with a remote device to which the communication companion device 102 is coupled after the authentication key (106) has been exchanged for authentication. In one embodiment, the communication companion device sharing application 219 launches automatically after the authentication key has been exchanged or otherwise verified between the control circuit 209 and the communication companion device 102.

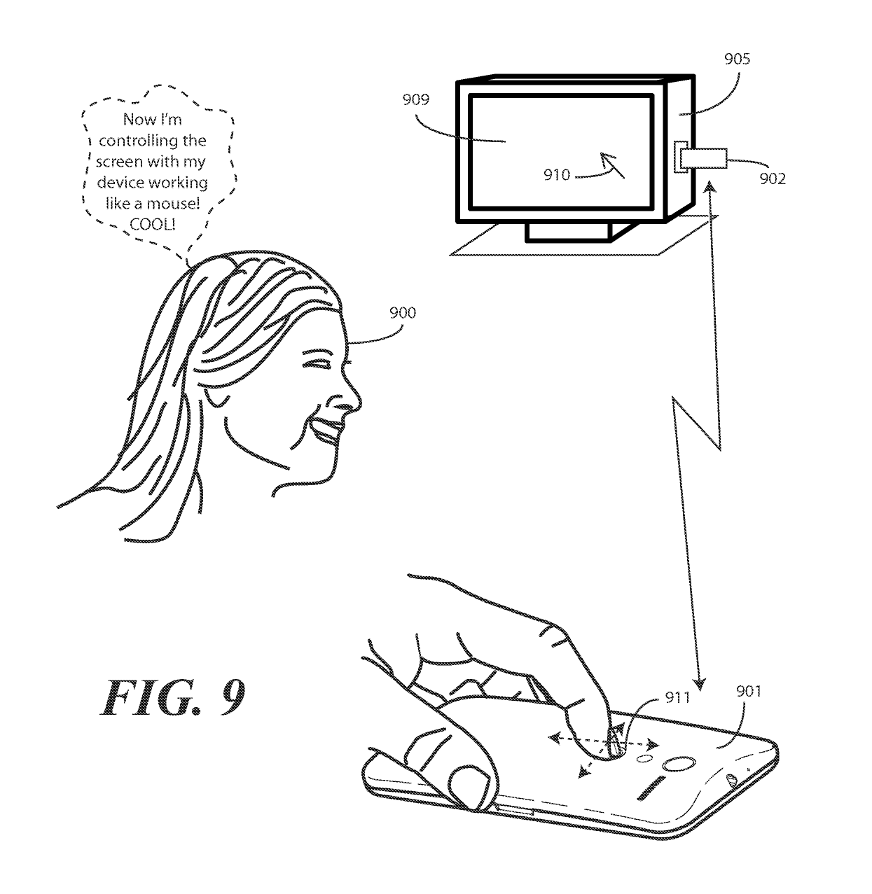

In one embodiment, the communication companion device sharing application 219 also allows one or more processors of the mobile communication device 101 to control data being presented on one or more output devices (107) of a remote device (105). For example, as will be described below with reference to FIG. 9, in one embodiment the mobile communication device 101 can be used as a mouse or other control device for the data presentation by detecting motion of the mobile communication device 101 and user input, such as actuation of one of the control buttons 205. For example, in one embodiment the user can move the mobile communication device 101 to control a cursor on the output device (107) of the remote device (105), while touching control button 205 to make selections. This will be shown in more detail with reference to FIG. 9 below.

To accommodate this mouse style control, in one embodiment the mobile communication device 101 includes one or more optional motion sensors or motion detection devices 223 to detect motion input. The motion detection devices 223 can take a variety of forms. For example, in one embodiment, an accelerometer can be included to detect motion of the mobile communication device 101. The accelerometer can also be used to determine the spatial orientation of the mobile communication device 101 in three-dimensional space by detecting a gravitational direction. In addition to, or instead of, the accelerometer, an electronic compass can be included to detect the spatial orientation of the mobile communication device 101 relative to the earth's magnetic field. Similarly, the motion detection devices 223 can include one or more gyroscopes to detect rotational motion of the mobile communication device 101. The gyroscope can be used to determine the spatial rotation of the mobile communication device 101 in three-dimensional space. Of course, combinations of these devices may also be used.

In one embodiment, the control circuit 209 is to receive motion signals from the motion sensors or motion detection devices 223. In one embodiment, the control circuit 209 is also to receive user input from the user interface, which includes control button 205. By receiving both, the control circuit 209 can control the presentation of data on one or more output devices (107) of a remote device (105) as a function of the motion signals and the user input. In this manner, the mobile communication device 101 can be used as a control device to control data presentation on the remote device (105).

In one embodiment, the control circuit 209 can be configured to cause the mobile communication device 101 to deliver energy to another device to charge the other device's battery or otherwise power the other device. For example, in a system configured in accordance with one or more embodiments of the disclosure the mobile communication device 101 can include a power interface 280. In one embodiment, the power interface 280 can comprise a micro-USB connector. In another embodiment, the power interface 280 can comprise a flexible cable terminating at a connector. It will be obvious to those of ordinary skill in the art having the benefit of this disclosure that embodiments are not so limited. For example, power interface 280 can comprise a wireless connection instead of the physical connector defined by a flexible cable and/or a micro-USB connector.

In one embodiment, the mobile communication device 101 includes an energy storage device that is operable with the power interface 280. A second device can be coupled to the power interface 280. In one embodiment, the control circuit 209 is configured to detect the other device being connected, and is then to cause the energy storage device to deliver a portion of its stored energy to the second device through the power interface 280. In one or more embodiments, the delivery occurs in accordance with one or more user defined rules. For instance, in one embodiment the user defined rules define which devices are authorized to receive energy from the energy storage device. Identification of authorized devices can be done in a variety of ways. Illustrating by example, the user defined rules identifying what other devices are permitted to share energy can be defined by device identifiers, e.g., serial numbers, service identifiers, e.g., telephone numbers or email addresses, or social identifiers, e.g., whether the user of the other device is “friends” or otherwise connected to the user. Where the device with which energy is to be shared is selected based upon a user profile or social networking profile, the sharing device can identify or detect this profile by wireless communication protocols, including near field communication, Bluetooth, Bluetooth LE, and so forth. Other identifiers will be obvious to those of ordinary skill in the art having the benefit of this disclosure. Accordingly, in one embodiment the control circuit 209 is to determine whether the second device is permitted to receive the portion prior to causing the energy storage device to deliver the portion.

In one embodiment, the communication companion device 102 is physically detachable from the mobile communication device 101. In one embodiment, the communication companion device 102 is physically stowable within a storage bay 222 of the mobile communication device 101. Turning to FIG. 3, illustrated therein in is such an embodiment. Specifically, a perspective view is shown where the communication companion device 102 has been withdrawn from, i.e., detached from, the storage bay 222 of the mobile communication device 101 for use. Upon detachment, a user can plug the HDMI connector 103 into a remote device (105) so that the mobile communication device 101 and the communication companion device 102 can authenticate and begin communicating to present information on the remote device. When the user is finished using the communication companion device 102, they simply reinsert the communication companion device 102 into the storage bay 222 to attach the communication companion device 102 to the mobile communication device 101 so that it may be easily transported with the mobile communication device 101 without fear of misplacement.

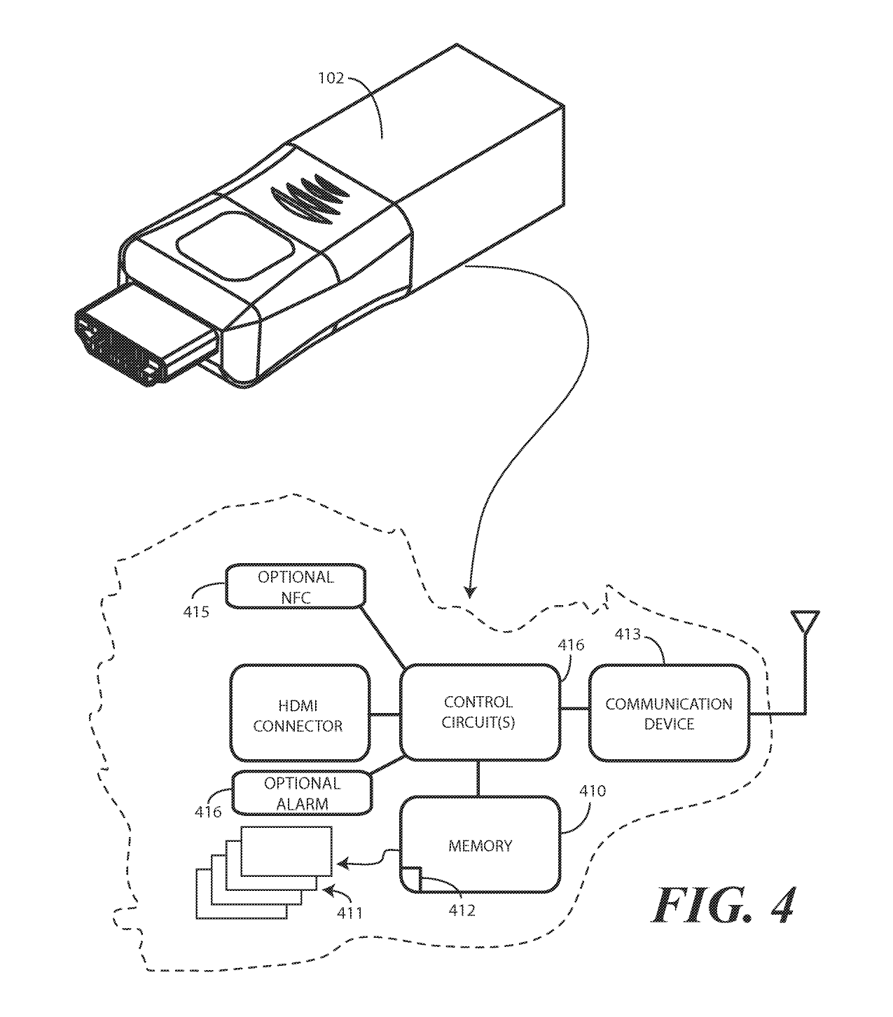

In one embodiment, the HDMI connector 103 comprises a pin layout that is compatible with both Type A and Type C HDMI connectors. These are generally 19-pin connectors with three data channels, a signal pin, an inverse signal pin, a power pin, and a ground pin. In one or more embodiments, as will be described below with reference to FIG. 4, the communication companion device 102 can include internal circuits. In such embodiments, the communication companion device 102 may also include an energy storage device such as a rechargeable lithium-ion or lithium-polymer battery. Accordingly, in one or more embodiments the storage bay 222 has pins complementary to those of the HDMI connector 103 so that any internal energy storage device of the communication companion device 102 can be recharged from the energy storage device of the mobile communication device 101 when the communication companion device 102 is stowed within the storage bay 222.

Turning now to FIG. 4, illustrated therein is one embodiment of a communication companion device 102 configured in accordance with one or more embodiments of the disclosure. Many of the components have functions similar to their counterparts. For example, the communication companion device 102 can include a control circuit 409, which can include one or more processors, and which is responsible for performing the various functions of the communication companion device 102. The control circuit 409 can be configured to process and execute executable software code, such as modules 411, to perform the various functions of the communication companion device 102. A storage device, such as memory 410, can store executable software code used by the control circuit 409 for device operation. In one embodiment, the memory 410 comprises at least some non-volatile memory 412. The authentication key (106) can be stored in this non-volatile memory 412 in one or more embodiments.

The communication companion device 102 can also include a communication circuit 413 that can be configured for wired and/or wireless communication with one or more other devices or networks. The communication companion device 102 can also include an optional near field communication circuit 415 that can communicate with a near field communication circuit (215) of a mobile communication device (101) where includes as well.

While many of the components are the same, in one or more embodiments the communication companion device 102 serves as a modem to effectuate access by a mobile communication device (101) to an output device of a remote device, with examples of the output device including the display, loudspeakers, and so forth. Since the communication companion device 102 serves to facilitate data communication with, and data translation for, the output device of the remote device, the components of the communication companion device 102 need not necessarily have the processing power of those in the mobile communication device (101) in one or more embodiments. In one embodiment, to help ensure that a user does not misplace the communication companion device 102, it can be equipped with an optional alarm 416 that can be configured to buzz, rattle, make noise, or take other alarm actions in response to signals from the mobile communication device (101).

Turning now to FIG. 5, illustrated therein is an alternate system 500 configured in accordance with one or more embodiments of the disclosure. While the system (100) of FIG. 1 was a wireless communication system, the system 500 of FIG. 5 is a wired communication system. The choice of wired over wireless can be based upon multiple factors, including reduced cost, increased simplicity, increased security, and so forth.

In FIG. 5, the system 500 includes a mobile communication device 501 and a communication companion device 502 to communicate with the mobile communication device 501. In one embodiment, the communication companion device 502 comprises an HDMI connector 503. The HDMI connector 503 can connect to an HDMI port 104 of a remote device 105. In one embodiment, the mobile communication device 501 and the communication companion device 502 are to exchange an authentication key 506 to enable communication therebetween when the HDMI connector 503 is coupled to the HDMI port 104 of the remote device 105. In one embodiment the mobile communication device 501 and the communication companion device 502 are to exchange the authentication key 506 without input from a user, thereby enabling data communication between the mobile communication device 501 and the communication companion device 502 automatically.

In FIG. 5, the communication companion device 502 is physically coupled to the mobile communication device 501. In one embodiment, the communication companion device 502 is physically coupled to the mobile communication device 501 by a wire. In another embodiment, the communication companion device 502 is physically coupled to the mobile communication device 501 by a hardware connector comprising a communication bus running from the mobile communication device 101 to the HDMI connector 503 to facilitate communication from the mobile communication device 101 to the remote device 105 through the HDMI connector 503 so that an output device 107 of the remote device 105 can be used by the mobile communication deice 101 for the presentation of data. Other couplings will be obvious to those of ordinary skill in the art having the benefit of this disclosure.

In one embodiment, memory devices in each of the mobile communication device 501 and the communication companion device 502 have authentication credentials that are both unique and hard coded in each device, and that can be verified by one or more processors operable with the memory devices to facilitate data communication. Illustrating by example, in one embodiment each of the mobile communication device 501 and the communication companion device 502 has an authentication key 506 that is written to non-volatile memory. By using one or more processors to confirm that their locally stored authentication keys match, the mobile communication device 501 and the communication companion device 502 can perform an authentication process to enable data communication. This is one example of “exchanging” the authentication key 506. Others will be obvious to those of ordinary skill in the art having the benefit of this disclosure.

Turning now to FIG. 6, illustrated therein is one example of a mobile communication device 501 suitable for use with the system (500) of FIG. 5. The mobile communication device 501 can be configured like the mobile communication device (101) of FIG. 2, and can have many of the same schematic components. However, in contrast to having a wireless, detachable communication companion device 502, in the embodiment of FIG. 5, the communication companion device 502 is physically coupled to the mobile communication device 501 by a flexible cable 600.

In this illustrative embodiment, the communication companion device 502 comprises a HDMI connector 103. In one embodiment, the communication companion device 502 can be used to deliver data to and from a remote device (105) so that the data can be presented on an output device (107) of the remote device (105). This provides a convenient way for the user of the mobile communication device 501 to share pictures, music, documents, and other data with a friend, for example, who may have an easier time viewing and/or hearing the data from the output device (107).

As shown in FIG. 6, in one or more embodiments the flexible cable 600 and the communication companion device 502 are stowable within the housing members 602,603 of the mobile communication device 601 when not in use. For example, when the user is not delivering data to a remote device (105), there may be no need for the communication companion device 502 to be dangling or extending from the mobile communication device 501. Accordingly, in one or more embodiments the user may stow the flexible cable 600 and the communication companion device 502 into a storage bay 622 of the mobile communication device 501. In the illustrative embodiment of FIG. 6, the flexible cable 600 emanates from the bottom 601 of the mobile communication device 501. The storage bay 622 extends from the connection point 604 along one side 605 of the bottom 601 of the mobile communication device 501 and up one side 606 of the mobile communication device 501.

When the communication companion device 502 is inserted into the storage bay 622, the exterior 607 of the communication companion device 607 and the exterior 608 of the flexible cable 600 define an exterior sidewall of the mobile communication device 601 that the user can hold in one embodiment. When the user desires to connect the communication companion device 502 to the HDMI port (104) of a remote device (105) share data via an output device (107), they may lift the communication companion device 502 to curl the HDMI connector 503 and flexible cable 600 out of the storage bay 622. In one or more embodiments, a length of the flexible cable 600 is greater than a length of the side 606 of the mobile communication device 501 to give the user more flexibility in data-sharing, as the external device attached to the HDMI connector 503 need not be as close to the mobile communication device 501.

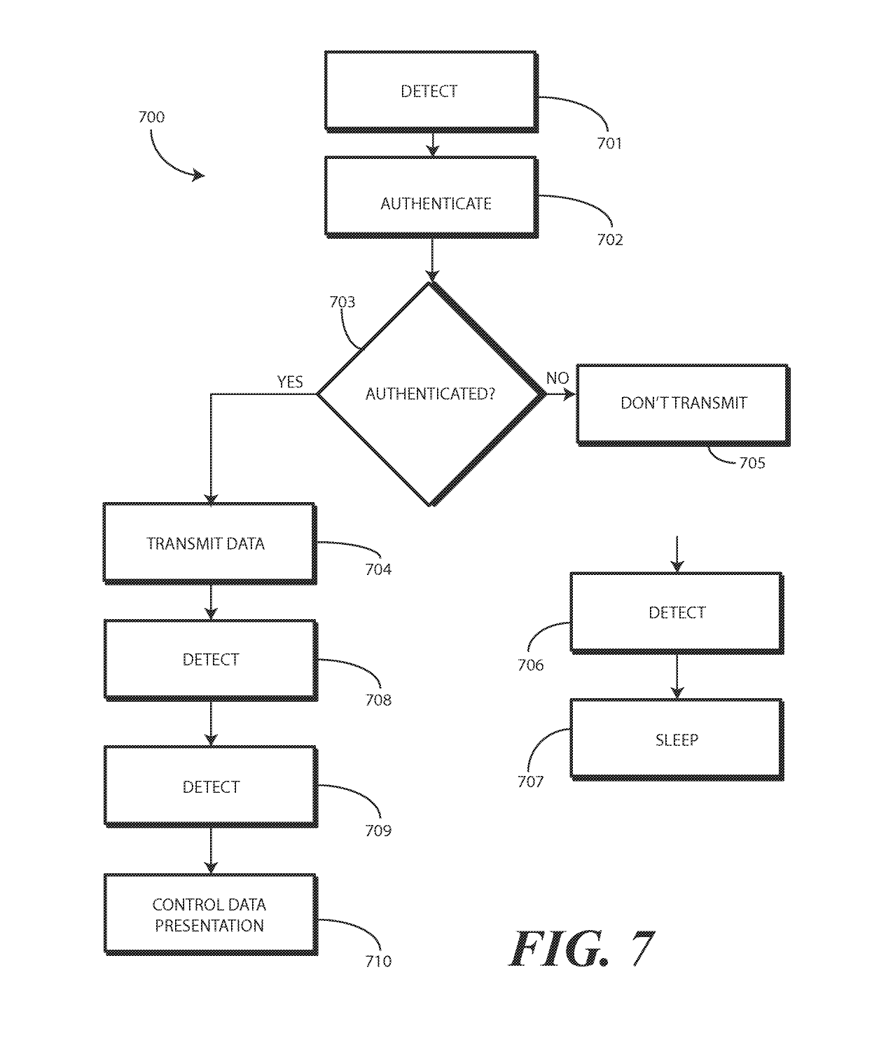

Turning now to FIG. 7, illustrated therein is one explanatory method 700 for electronic communication between a mobile communication device and a communication companion device in accordance with one or more embodiments of the disclosure. At step 701, the method 700 detects attachment of a HDMI connector of a communication companion device to a remote device. In one or more embodiments, one or more processors of the communication companion device perform the step 701 of detecting.

At step 702, the method 700 authenticates the communication companion device with a mobile communication device. In one embodiment, step 702 comprises authenticating the communication companion device with the mobile communication device without user input. For example, in one embodiment step 702 comprises verifying a common authentication key is stored in a memory of both the mobile communication device and the communication companion device. In one embodiment, this step 702 is performed by one or more processors of each of the mobile communication device and the communication companion device. In one embodiment, step 702 comprises verifying that the common authentication key is stored in non-volatile memory of both the mobile communication device and the communication companion device.

At decision 703, the method 700 determines whether authentication has been accomplished. Where it has, data can be transferred from the mobile communication device to the communication companion device for presentation on one or more output devices of the remote device at step 704. In one embodiment, step 704 comprises transferring photos from the mobile communication device to the communication companion device for presentation on one or more displays of the remote device. In one embodiment, step 704 comprises transferring music from the mobile communication device to the communication companion device for presentation on one or more audio output devices of the remote device. In one embodiment, step 704 comprises transferring multimedia content from the mobile communication device to the communication companion device for presentation on one or more output devices of the remote device.

In one embodiment, the transferring of step 704 occurs wirelessly. In another embodiment, the transferring of step 704 occurs through a physical connection such as a flexible wire or communication bus. Where authentication was not confirmed at decision 703, data transfer can be precluded at step 705.

In one embodiment, at step 705, the method 700 can detect attachment of the HDMI connector to the mobile communication device. For example, in one or more embodiments, the HDMI connector is stowable in a storage bay of the mobile communication device. This stowing operation can be detected at step 705 in one embodiment. Where this occurs, at optional step 706 the method 700 can place the one or more processors of the communication companion device in a low power or sleep mode as data communication between the mobile communication device and the communication companion device is not required while the communication companion device is stowed within the storage bay.

As noted above, in one or more embodiments the method 700 allows a user to use a mobile communication device as a control device to control presentation of the data on the one or more output devices of the remote device. This can occur at optional steps 708-710. For example, at optional step 708, the method can receive motion signals from one or more motion sensors. AT optional step 709, the method 700 can receive user input from a user interface, such as a touch-sensitive display, one or more control buttons, and so forth. At optional step 710, the method 700 can control the presentation of data on one or more output devices of a remote device as a function of the motion signals and the user input.

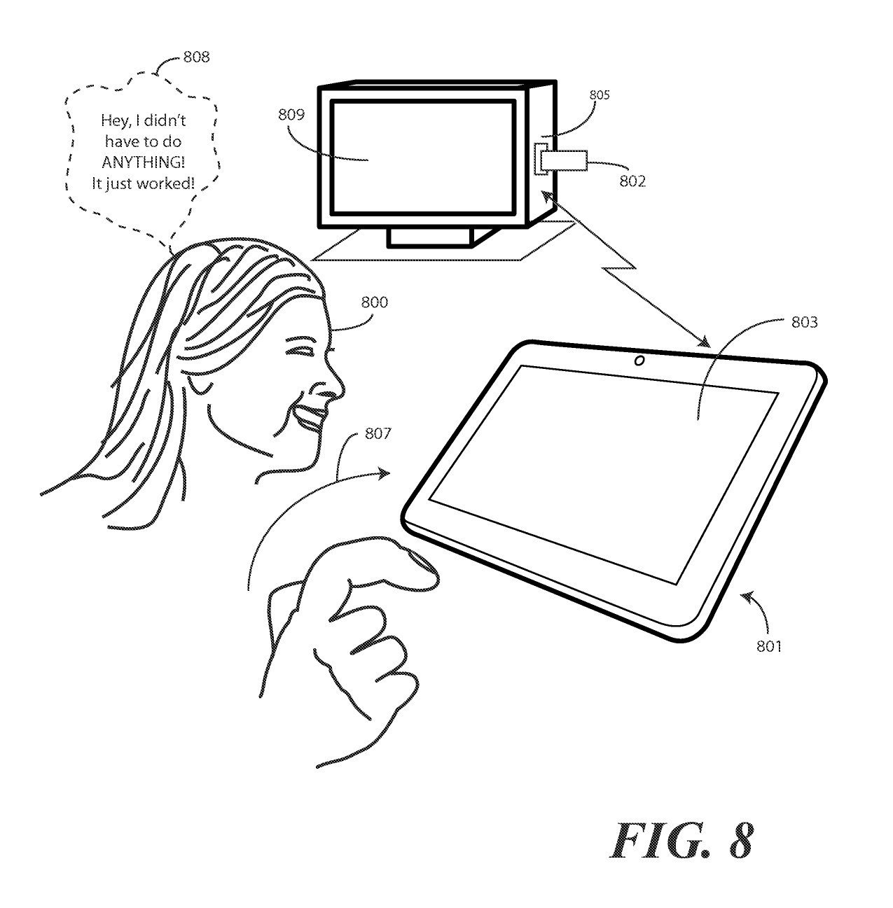

Turning now to FIG. 8, illustrated therein is an explanatory use case for one or more embodiments of the disclosure. A user 800 is making a presentation using a tablet electronic device 801. The tablet electronic device 801 has a touch-sensitive display 803. The user 800 has detached a communication companion device 802 from a storage bay (not shown) of the tablet device 801 and has plugged its HDMI connector into the HDMI port of a remote device 805, which happens to be a video monitor in this illustrative embodiment.

As soon as the HDMI connector is connected to the HDMI port of the remote device 805, in one embodiment the tablet device 801 and communication companion device 802 perform an authentication procedure to enable communication. In one embodiment, this comprises exchanging or verifying that an authentication key of one device matches this other. In one embodiment, this authentication process happens automatically and without any input from the user 800. As shown by the user's response 808, this results in a seamless and effortless initiation of communication between the tablet device 801 and the communication companion device 802, leaving the user 800, who had to do nothing other than plug in the communication companion device 802, to say, “Hey, I didn't have to do ANYTHING. It just worked!” This is due to the authentication process occurring without user input as described above. The user 800 is thus able to drive the presentation using touch input 807 on the touch-sensitive display 803 of the tablet device 801 while data is presented on a display 809 of the remote device 805 for the audience to see.

Turning now to FIG. 9, illustrated therein is another explanatory use case for one or more embodiments of the disclosure. In the use case of FIG. 9, the user 900 is using a mobile communication device 901 as a control device to control the presentation of data on a display 909 of a remote device 905. In one embodiment, the mobile communication device 901 does not have its own display, but rather leverages the display 909 of the remote device 905 as its display when in operation. In other embodiments, the mobile communication device 901 includes a locally resident display that can be used when the mobile communication device 901 is not in communication with the remote device 905 via the communication companion device 902.

As shown in FIG. 9, a user 900 has detached the communication companion device 902 from a storage bay (not shown) of the mobile communication device 901 and has plugged its HDMI connector into the HDMI port of a remote device 905, which happens to be a video monitor in this illustrative embodiment. As soon as the HDMI connector is connected to the HDMI port of the remote device 905, in one embodiment the mobile communication device 901 and the communication companion device 902 perform an authentication procedure to enable communication. In one embodiment, this authentication process happens automatically and without any input from the user 900.

As noted above, a communication companion device sharing application (219) allows one or more processors of the mobile communication device 901 to control data being presented on the display 909 of the remote device 905. Such is the case here. As shown in FIG. 9, the user 900 can move the mobile communication device 901 to control a cursor 910 on the display 909 of the remote device 905, while touching control button 911 to make selections and to provide user input.

In one embodiment, the mobile communication device 901 is a mouse-sized device that communicates with the communication companion device 902. The communication companion device 902 allows the remote device 905 to serve as the visual feedback device for the mobile communication device 901. When connected to such a screen, the mobile communication device 901 becomes the input device of a computing system (located within the mobile communication device 901) while the remote device 905 serves as the monitor. Advantageously, the system of FIG. 9 allows the user 900 to have a mobile communication device 901 that can be, for example, a smartphone when the communication companion device 902 is not in use, but that doubles as a mouse when the communication companion device 902 is in use.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A system, comprising:
a mobile communication device; and
a communication companion device to communicate with the mobile communication device, the communication companion device comprising a high-definition multimedia (HDMI) connector to couple to a remote device;
the mobile communication device and the communication companion device to exchange an authentication key to enable communication therebetween when the HDMI connector is coupled to the remote device;
the mobile communication device and the communication companion device to exchange the authentication key without input from a user.

2. The system of claim 1, the mobile communication device to, after authentication with the communication companion device, transfer data to the communication companion device for presentation on one or more output devices of the remote device.

3. The system of claim 2, the mobile communication device comprising:
one or more processors;
one or more motion sensors operable with the one or more processors; and
a user interface operable with the one or more processors;
the one or more processors to:
receive motion signals from the one or more motion sensors;
receive user input from the user interface; and
control the presentation on the one or more output devices of the remote device as a function of the motion signals and the user input.

4. The system of claim 3, the user input comprising actuation of a control button of the mobile communication device.

5. The system of claim 1, the communication companion device comprising a wireless communication companion device to wirelessly communicate with the mobile communication device.

6. The system of claim 5, the wireless communication companion device physically detachable from, and physically stowable within, a storage bay of the mobile communication device.

7. The system of claim 1, the communication companion device physically coupled to the mobile communication device by one of a cable or a communication bus.

8. The system of claim 7, the communication companion device physically stowable within a storage bay of the mobile communication device.

9. The system of claim 1, the mobile communication device comprising:
one or more processors;
a memory device operable with the one or more processors, the memory device comprising at least some non-volatile memory;
a communication device operable with the one or more processors;
the authentication key stored in the at least some non-volatile memory.

10. The system of claim 9, the communication companion device comprising:
one or more other processors; and
an other memory device operable with the one or more other processors, the other memory device comprising at least some other non-volatile memory;
the authentication key also stored in the at least some other non-volatile memory.

11. A method, comprising:
detecting attachment of a high-definition multimedia (HDMI) connector of a communication companion device to a remote device;
authenticating the communication companion device with a mobile communication device without user input; and
transferring data from the mobile communication device to the remote device.

12. The method of claim 11, the authenticating comprising verifying an authentication key is stored in non-volatile memory of both the mobile communication device and the communication companion device.

13. The method of claim 11, the data comprising photos.

14. The method of claim 11, the data comprising music.

15. The method of claim 11, the data comprising multimedia content.

16. The method of claim 11, further comprising presenting the data on one or more output devices of the remote device.

17. The method of claim 16, further comprising using the mobile communication device as a control device to control presentation of the data on the one or more output devices of the remote device.

18. The method of claim 11, further comprising also detecting attachment of the HDMI connector to the mobile communication device and, after the also detecting attachment, placing one or more processors of the communication companion device in a low-power or sleep mode.
